(19) United States
(12) Patent Application Publication
(10) Pub. No.: US 2002/0070564 A1
(43) Pub. Date: Jun. 13, 2002

(54) Door closer

(76) Inventors: Satoshi Ohta, Kosai-shi (JP); Takayoshi Aoyama, Toyohashi-shi (JP); Toru Yoshida, Aichi-ken (JP); Tadashi Isozumi, Shizuoka-ken (JP)

Correspondence Address: NILLES & NILLES, S.C., INTELLECTUAL PROPERTY ATTORNEYS, FIRSTAR CENTER, SUITE 2000, 777 EAST WISCONSIN AVENUE, MILWAUKEE, WI, 53202-5345, US

(21) Appl. No.: 09/938,280

(22) Filed: Aug. 23, 2001

(30) Foreign Application Priority Data
Aug. 24, 2000 (JP) 2000-254424

(51) Int. Cl. E05C 3/06

(52) U.S. Cl. 292/201

(57) ABSTRACT

A door closer includes a latch that engages with a striker and first and second ratchets that engage with the latch. When the latch receives the striker and rotates from an initial position to a fully latched position, the door is moved to a fully closed position. When the ratchets disengage from the latch, the latch returns from the fully latched position to the initial position. The striker thus disengages from the latch, and the door moves from the fully closed position to a released position. After the ratchets disengage from the latch, each ratchet is held at a position at which the ratchet cannot engage with the latch unless the door is located at a predetermined position separate from the released position in a door opening direction.

### BACKGROUND OF THE INVENTION

The present invention relates to door closers that maintain a vehicle's doors such as side doors or trunk doors as closed.

A door closer is installed in a vehicle's door for maintaining the door as closed. To fully close the door, the door must be pressed with a relatively large force against resilient force of a weather strip lined along the door frame and reactive force that acts against operation of the door closer.

Japanese Examined Patent Publication No. 5-27748 describes a door closer that forcibly latches a door at a fully closed position when the door is located adjacent to the fully closed position. Further, when a door opener switch located in a passenger compartment is turned on, the door closer activates a motor to release the door from the fully closed position.

However, after the door is released from the fully closed position, undesired force caused by, for example, a wind or the weight of the door may act to urge the door in a direction to close the door. In this case, the door closer determines that the door is located adjacent to the fully closed position and latches the door at the fully closed position. In other words, the door may be latched at an undesired timing. If this is the case, the door opener switch need be turned on again.

### BRIEF SUMMARY OF THE INVENTION

Accordingly, it is an objective of the present invention to provide a door closer that prevents a door from being closed due to an undesired latching operation after the door is released from a fully closed position.

To achieve the foregoing and other objectives and in accordance with the purpose of the present invention, the invention provides a door closer that holds a door at a fully closed position by engaging with a prescribed engagement member. When the engagement member is disengaged from the door closer, the door moves to a released position that is located slightly separate from the fully closed position in a door opening direction. The door closer includes a latch, which engages with the engagement member. The latch rotates between an initial position at which the latch receives the engagement member and a fully latched position. When the latch rotates from the initial position to the fully latched position after receiving the engagement member, the door is moved to the fully closed position. An urging member urges the latch toward the initial position. A ratchet is urged toward the latch. When the latch reaches the fully latched position, the ratchet engages with the latch to hold the latch at the fully latched position. An actuation mechanism separates the ratchet from the latch to disengage the ratchet from the latch. When the ratchet disengages from the latch, the urging member returns the latch from the fully latched position to the initial position such that the engagement member disengages from the latch and the door moves from the fully closed position to the released position. A detection device detects that the door is located at a predetermined position separate from the released position in the door opening direction. After the ratchet disengages from the latch, the actuation mechanism holds the ratchet at a position at which the ratchet cannot engage with the latch unless the detection device detects that the door is located at the predetermined position.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a perspective view showing a rear potion of a vehicle provided with an embodiment of a door closer according to the present invention;

FIG. 2 is a plan view showing the door closer of FIG. 1;

FIG. 2A is a plan view mainly showing a latch of FIG. 2;

FIG. 3 is an exploded perspective view showing the door closer;

FIG. 4 is a plan view showing components of the door closer;

FIG. 5 is a view showing the door closer viewed as indicated by arrow X of FIG. 2;

FIG. 6 is a plan view for explaining the operation of the door closer;

FIG. 6A is a plan view mainly showing a latch of FIG. 6;

FIG. 7 is a plan view for explaining the operation of the door closer;

FIG. 7A is a plan view mainly showing a latch of FIG. 7;

FIG. 8 is a plan view for explaining the operation of the door closer;

FIG. 8A is a plan view mainly showing a latch of FIG. 8;

FIG. 9 is a plan view for explaining the operation of the door closer;

FIG. 9A is a plan view mainly showing a latch of FIG. 9;

FIG. 10 is a plan view for explaining the operation of the door closer;

FIG. 10A is a plan view mainly showing a latch of FIG. 10;

FIG. 11 is a partially broken plan view showing an actuator for actuating the door closer;

FIG. 12 is a circuit diagram showing the electrical configuration of the door closer; and

FIG. 13 is a timing chart showing the operation of the door closer.

### DETAILED DESCRIPTION OF THE PREFERRED EMBODIMENTS

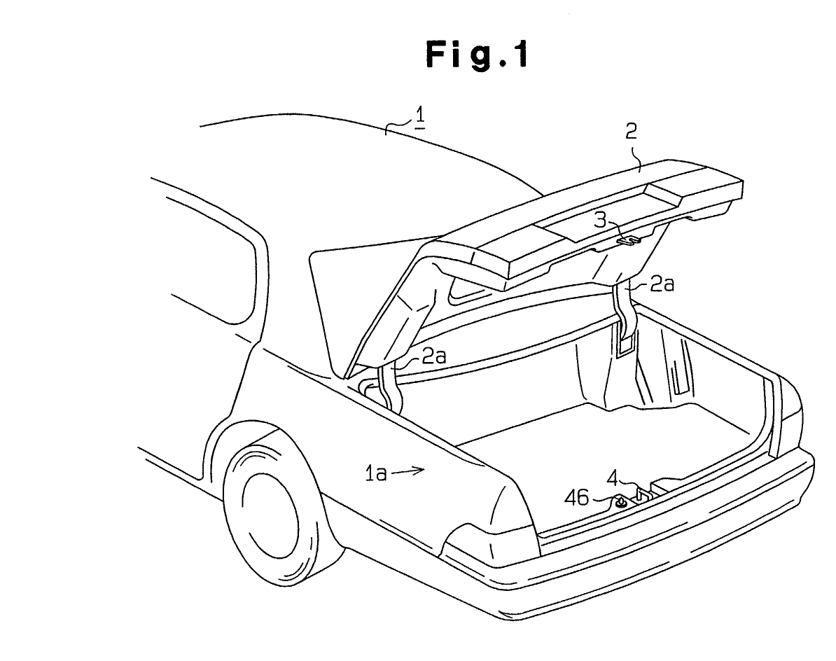

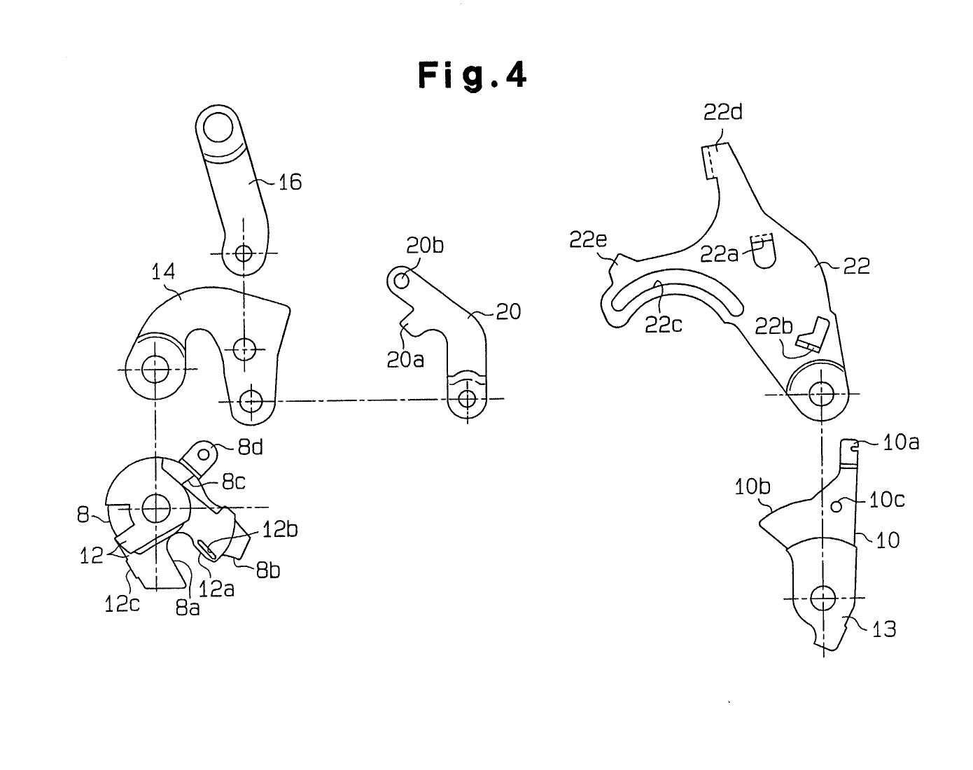

An embodiment of the present invention will now be described with reference to FIGS. 1 to 13. FIG. 1 is a perspective view showing a rear portion of a vehicle 1 at which a trunk 1a is located. A trunk door 2 closes the trunk 1a. The trunk door 2 has a substantially L-shaped cross-sectional shape. The trunk door 2 is supported by the body frame of the vehicle 1 through a hinge mechanism 2a.

A door closer 3 is located at the middle of the distal end of the trunk door 2 in a lateral direction of the vehicle 1. A striker 4, or an engagement member, is installed in the body frame at a position corresponding to the door closer 3.

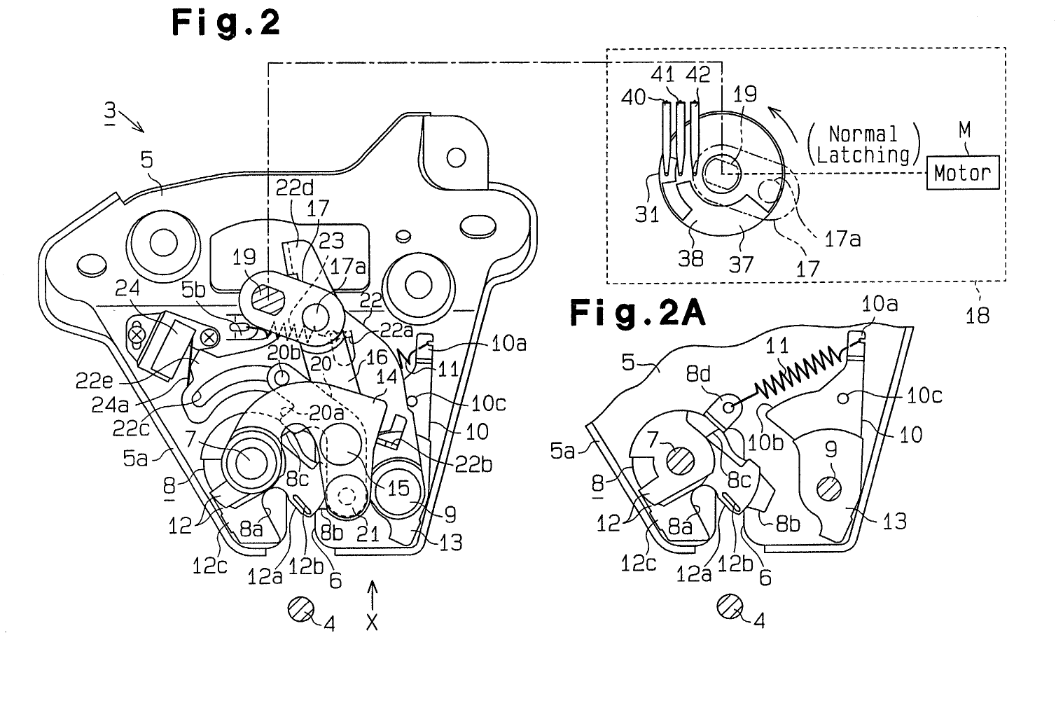

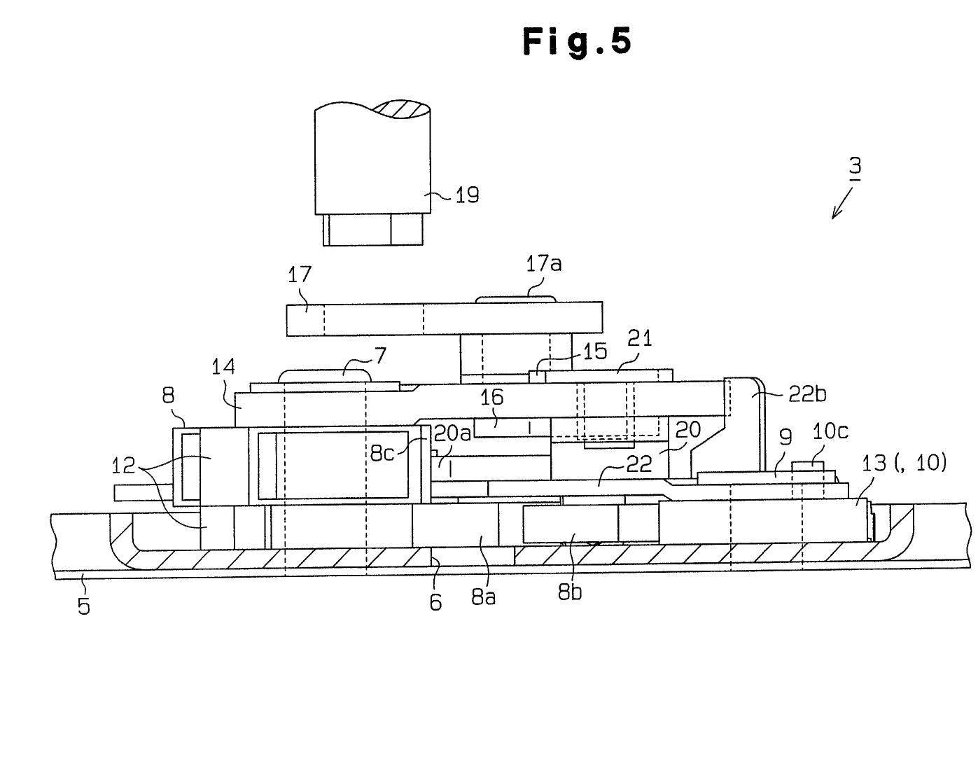

As shown in FIGS. 2 to 5, the door closer 3 includes a base plate 5 that has a receiving groove 6 for receiving the striker 4. As shown in FIG. 5, a support shaft 7 is secured to the base plate 5 in the vicinity of the receiving groove 6. The axis of the support shaft 7 is perpendicular to the base plate 5. A substantially disk-like latch 8 is rotationally supported by the support shaft 7. FIG. 5 is a view showing the door closer 3 viewed as indicated by arrow X of FIG. 2.

The latch 8 has a double structure firmed by a thick portion and a thin portion. The thick portion is located around the axis of the latch 8. The thin portion projects radially from the thick portion. The thin portion includes a recess 8a and a engagement surface 8b. When the striker 4 enters the receiving groove 6 of the base plate 5, the recess 8a receives the striker 4. The engagement surface 8b is formed at a radial distal end of the thin portion. The thick portion includes an engagement surface 8c. In the state shown in FIGS. 2 and 2A, the latch 8 is located at its initial position at which the latch 8 abuts against a side wall 5a of the base plate 5. The side wall 5a prevents the latch 8 from rotating clockwise from the initial position, as viewed in the drawings.

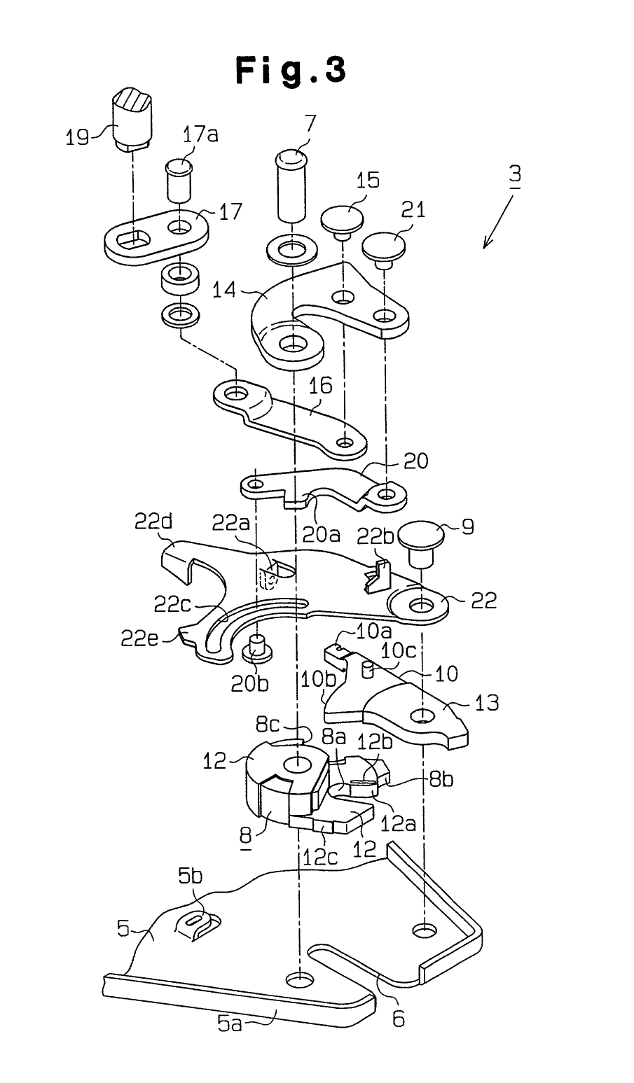

As shown in FIGS. 3 and 5, a support shaft 9 is secured to the base plate 5 at an opposite side of the receiving groove 6 to the support shaft 7. The axis of the support shaft 9 is perpendicular to the base plate 5. A first ratchet 10 is rotationally supported by the support shaft 9.

As shown in FIGS. 2 to 4, the latch 8 includes an engagement portion 8d that engages with a coil spring 11, or an urging member. In the same manner, the first ratchet 11 includes an engagement portion 10a that engages with the coil spring 11. The coil spring 11 is thus suspended between the engagement portions 8d, 10a. The ratchet 8 and the first latch 10 are urged toward each other through the coil spring 11.

When the latch 8 is located at its initial position, the engagement portion 8d of the latch 8 is located above a line that connects the axis of the support shaft 7 to the engagement portion 10a of the first ratchet 10, as viewed in FIG. 2A. In this state, the coil spring 11 urges the latch 8 clockwise and the first ratchet 10 counterclockwise as viewed in the drawing, or toward the latch 8. The first ratchet 10e gages with the side wall 5a of the base plate 5 and does not rotate counterclockwise.

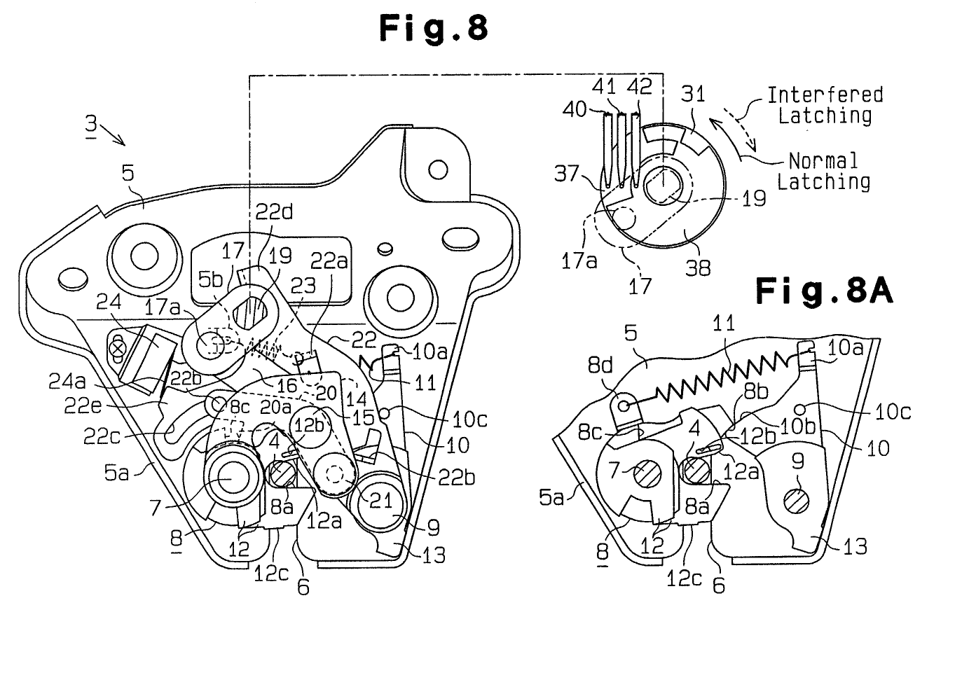

As shown in FIGS. 2 to 4, the first ratchet 10 includes an engagement piece 10b that engages with the engagement surface 8b of the latch 8. When the engagement piece 10b engages with the engagement surface 8b, the latch 8 is located at its fully latched position (see FIG. 8A). The first ratchet 10 includes an engagement pin 10c that is parallel with the axis around which the first ratchet 10 rotates.

The latch 8 and the first ratchet 10 are formed of metal. As shown in FIGS. 2 to 4, the latch 8 is encompassed by a resin cover 12 except for the engagement surfaces 8b, 8c that are exposed. The resin cover 12 reduces friction between the latch 8 and other components, thus enabling the latch 8 to move smoothly. The resin cover 12 also suppresses noise caused by movement of the latch 8. The first ratchet 10 is encompassed by a resin cover 13 at a position close to its basal end. The resin cover 13 reduces frication between the first ratchet 10 and other components, thus enabling the first ratchet 10 to move smoothly. The resin cover 13 also suppresses noise caused by movement of the first ratchet 10.

When each engagement surface 8b, 8c engages with a component, an increased force acts on the engagement surface 8b, 8c. Thus, if the engagement surface 8b, 8c were encompassed by a resin cover, the resin cover would be damaged by or adhered to the component. To avoid this, each engagement surface 8b, 8c, which is formed of metal, is exposed without being encompassed by the resin cover.

The resin cover 12 has a relatively thick damper 12a at the wall of the recess 8a. A slit 12b is formed in the damper 12a. When the striker 4 is received by the recess 8a through the receiving groove 6 of the base plate 5, the striker 4 strikes the damper 12a that suppresses impact and noise caused by the striker 4. The slit 12b improves the impact damping performance of the damper 12a. The resin cover 12 has a relatively thick damper 12c that encompasses a portion of the latch 8 that strikes the side wall 5a of the base plate 5. The damper 12c suppresses impact and noise when the latch 8 strikes the side wall 5a.

As shown in FIGS. 2 to 5, a drive cam 14 is located adjacent to the latch 8 through the resin cover 12. The drive cam 14 is rotationally supported by the support shaft 7. The drive cam 14 is linked to a link 16 by a support shaft 15 at a substantially middle portion of the drive cam 14. The link 16 is located below the drive cam 14, as viewed in FIG. 5. The axis of the support shaft 15 is perpendicular to the base plate 5.

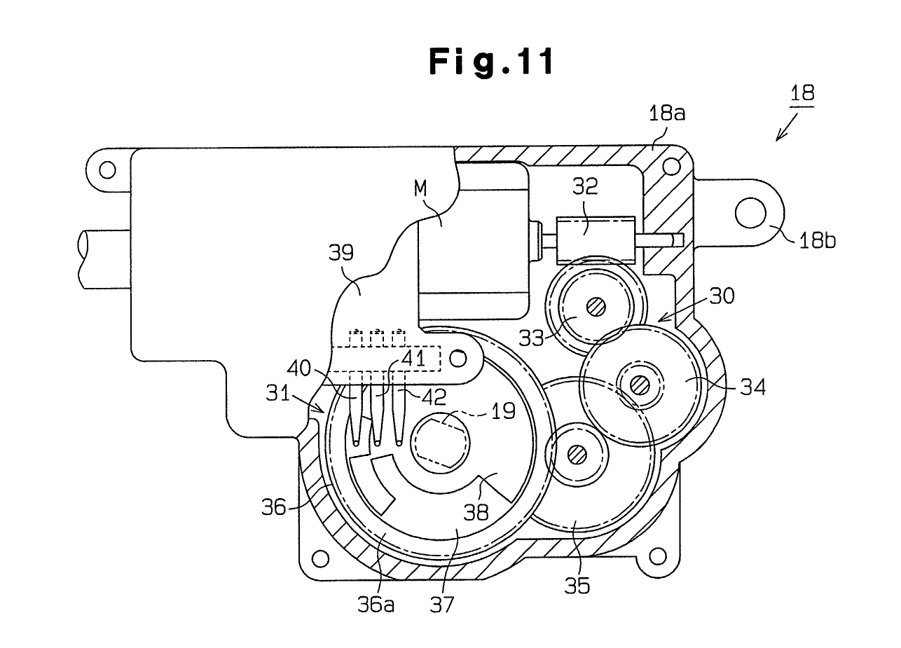

The link 16 is rotationally supported by an end of a connecting arm 17 through a connecting pin 17a. The connecting arm 17 is connected to an output shaft 19 of an actuator 18 that has a motor M as a drive source. The connecting arm 17 rotates integrally with the output shaft 19. The actuator 18 is fastened to the base plate 5 with a spring (not shown). The actuator 18 will be described later with reference to FIG. 11. The motor M is capable of rotating in opposite directions. This enables the connecting arm 17 to rotate around the output shaft 19 in opposite directions. When the connecting arm 17 rotates, the drive cam 14 rotates with respect to the support shaft 7.

Normally, the motor M rotates in a positive direction to move the connecting arm 17 counterclockwise, as viewed in FIG. 2. However, for example, if an object is clamped between the trunk door 2 and the body frame when the door closer 3 is closing the trunk door 2, the motor M rotates in a negative direction to move the connecting arm 17 clockwise.

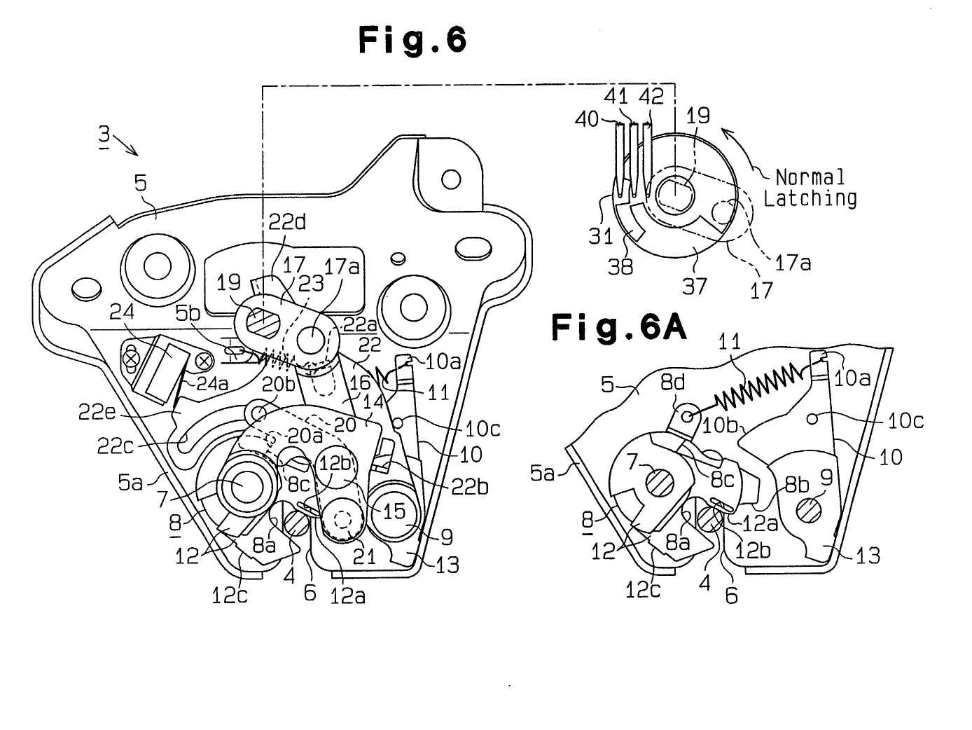

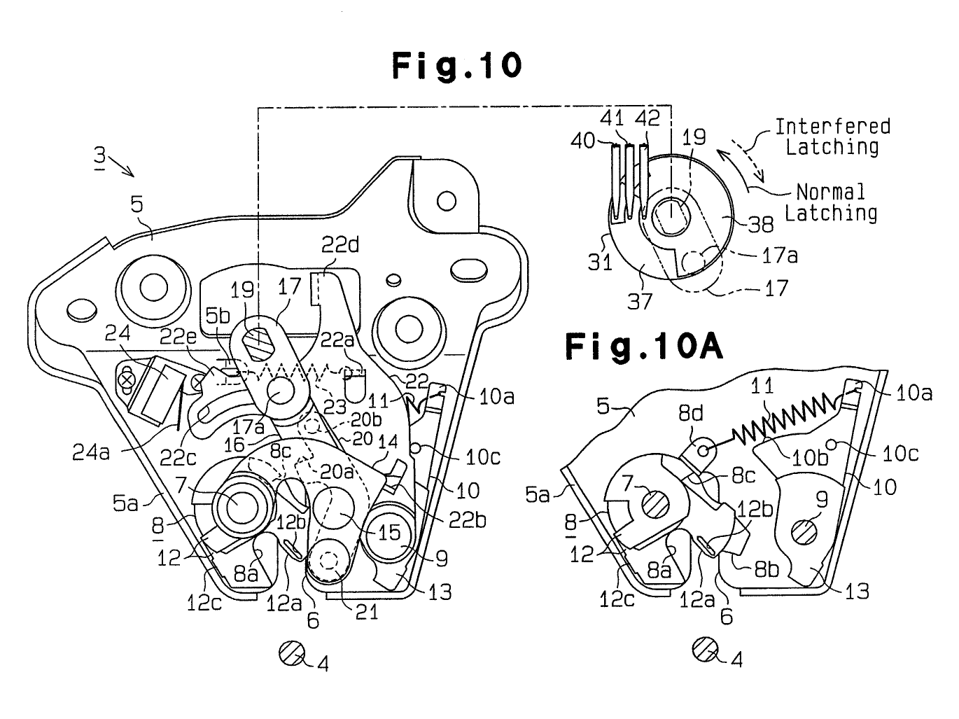

In the state shown in FIGS. 2 and 6, the connecting arm 17 is located at an open-door initial position. As long as the trunk door 2 is open, the connecting arm 17 is located at this position. In the state shown in FIG. 8, the connecting arm 17 is located at a closed-door initial position. As long as the trunk door 2 is closed, the connecting arm 17 is located at this position. In the state shown in FIG. 10, the connecting arm 17 is located at its intermediate stop position.

When the connecting arm 17 is located at the open-door initial position of FIGS. 2 and 6 or the closed-door initial position of FIG. 8, the drive cam 14 is located at a neutral position.

As shown in FIGS. 3 and 5, a second ratchet 20 is connected to the drive cam 14 through a support shaft 21. The second ratchet 20 is located below the drive cam 14, as viewed in FIG. 5, and does not interfere with the link 16. The second ratchet 20 includes an engagement piece 20a that engages with the engagement surface 8c of the latch 8. When the engagement piece 20a engages with the engagement surface 8c, as shown in FIG. 6, the latch 8 is located at a latching start position. A follower pin 20b is passed through an end of the second ratchet 20 from below, as viewed in FIG. 5.

As shown in FIGS. 2 to 5, an operational lever 22 is rotationally supported by the support shaft 9 and is located above the first ratchet 10, as viewed in FIG. 5. The operational lever 22 has an engagement portion 22a that engages with an end of a coil spring 23. The other end of the soil spring 23 engages with an engagement portion 5b of the base plate 5. The engagement portion 5b does not interfere with the operational lever 22. The coil spring 23 urges the operational lever 22 counterclockwise, as viewed in FIG. 2. The operational lever 22 has an engagement projection 22b in the vicinity of the support shaft 9. The engagement projection 22b engages with the outer periphery of the drive cam 14.

The operational lever 22 has an arched guide groove 22c. The follower pin 20b of the second ratchet 20 is accommodated in the guide groove 22c. Since the coil spring 23 urges the operational lever 22 counterclockwise, as viewed in FIG. 2, the second ratchet 20 connected to the operational lever 22 through the follower pin 20b is urged toward the latch 8. The engagement piece 20a of the second ratchet 20 abuts against the outer side of the thick portion of the latch 8 that includes the engagement surface 8c. Thus, if the latch 8 is located at the latching start position, the engagement piece 20a engages with the engagement surface 8c, as shown in FIG. 6. In this state, the engagement piece 20a strikes the outer periphery of the latch 8. However, the resin cover 12 of the latch 8 damps impact and noise caused by the striking.

The operational lever 22 includes an operational arm 22d. A manually operable, door handle (not shown) is connected to the operational arm 22d. The door handle is manipulated to rotate the operational lever 22 with respect to the support shaft 9 clockwise, as viewed in FIG. 2.

As shown in FIG. 2, a limit switch 24 is secured to the base plate 5 in the vicinity of the operational lever 22. If the latch 8 is located at the closing start position and the engagement piece 20a of the second ratchet 20 engages with the engagement surface 8c, as shown in FIG. 6, a projection 22e of the operational lever 22 moves a movable piece 24a of the limit switch 24, thus turning off the limit switch 24. This enables the actuator 18 to start latching operation of the trunk door 2 to fully close the same.

FIG. 11 shows the actuator 18. The actuator 18 has a case 18a that accommodates the motor M, a deceleration mechanism 30, and a rotational position sensor 31. The decelerating mechanism 30 decelerates the motor M. The rotational position sensor 31 detects a rotational position of the connecting arm 17. The case 18a has three attachment pieces 18b (only one is shown). When the attachment pieces 18b are fastened to the base plate 5 with springs, the actuator 18 is secured to the base plate 5.

The deceleration mechanism 30 includes a worm 32 and four reduction gears 33, 34, 35, 36. The worm 32 is secured to the rotational shaft of the motor M. The output shaft 19 is fixed to the reduction gear 36, or the final gear. An insulating disk plate 37 is secured to a side 36a of the reduction gear 36. A conductor 38 covers a portion of the disk plate 37. In this manner, a predetermined conducting pattern is formed on the side 36a of the reduction gear 36.

The rotational position sensor 31 includes a base plate 39, and first, second, and third contact elements 40, 41, 42. The base plate 39 is secured to the inner wall of the case 18a. The first to third contact elements 40-42 project from the base plate 39. The distal end of each contact element 40-42 contacts the conducting pattern. More specifically, the first to third contact elements 40-42 contact the conducting pattern along a line that extends in a radial direction of the plate 37. That is, the first contact element 40 contacts a radial outer portion of the conducting pattern (a first pattern portion), the second contact element 41 contacts a radial intermediate portion (a second pattern portion), and the third contact element 42 contacts a radial inner portion (a third pattern portion). The first to third pattern portions are different from one another. The first and second pattern portions include a portion at which the plate 37 is exposed. The third pattern portion does not have a portion at which the plate 37 is exposed and is encompassed by the conductor 38 along the entire circumference of the third pattern portion.

When the first contact element 40 and the third contact element 42 contact the conductor 38, the first contact element 40 is electrically connected to the third contact element 42 through the conductor 38. If the first contact element 40 separates from the conductor 38, the first contact element 40 is electrically disconnected from the third contact element 42. It is defined that the first contact element 40 is in ON state when the first contact element 40 is electrically connected to the third contact element 42. In contrast, it is defined that the first contact element 40 is in OFF state if the first contact element 40 is electrically disconnected from the third contact element 42.

When the second contact element 41 and the third contact element 42 contact the conductor 38, the second contact element 41 is electrically connected to the third contact element 42 through the conductor 38. If the second contact element 41 separates from the conductor 38, the second contact element 41. is electrically disconnected from the third contact element 42. It is defined that the second contact element 41 is in ON state when the second contact element 41 is electrically connected to the third contact element 42. In contrast, it is defined that the second contact element 41 is in OFF state if the second contact element 41 is electrically disconnected from the third contact element 42.

In other words, the electrical connection states of the first contact element 40 and the second contact element 41 with respect to the third contact element 42 are changed depending on the position of the reduction gear 36, or the rotational position of the connecting arm 17. The rotational position of the connecting arm 17 is thus determined in accordance with the ON/OFF states of the first and second contact elements 40, 41.

When the connecting arm 17 is located at the open-door initial position as shown in FIGS. 2 and 6, the first contact element 40 is electrically disconnected from the third contact element 42 and the second contact element 41 is electrically connected to the third contact element 42.

If the connecting arm 17 is slightly rotated from the open-door initial position counterclockwise, as viewed in FIGS. 2 and 6, the first contact element 40 and the second contact element 41 are both electrically connected to the third contact element 42. As the connecting arm 17 is further rotated in the same direction, the first and second contact elements 40, 41 are maintained as electrically connected to the third contact element 42 until the connecting arm 17 reaches a position immediately adjacent to the closed-door initial position of FIG. 8.

When the connecting arm 17 is located at the closed-door initial position, as shown in FIG. 8, the first and second contact elements 40, 41 are electrically disconnected from the third contact element 42. As the connecting arm 17 is rotated further counterclockwise, the first and second contact elements 40, 41 are maintained as electrically disconnected from the third contact element 42 until the connecting arm 17 reaches a position immediately adjacent to the intermediate stop position of FIG. 10.

If the connecting arm 17 is located at the intermediate stop position, as shown in FIG. 10, the first contact element 40 is electrically connected to the third contact element 42. As the connecting arm 17 is rotated further counterclockwise, the first contact element 40 is maintained as electrically connected to the third contact element 42 until the connecting arm 17 reaches a position immediately adjacent to the open-door initial position of FIGS. 2 and 6.

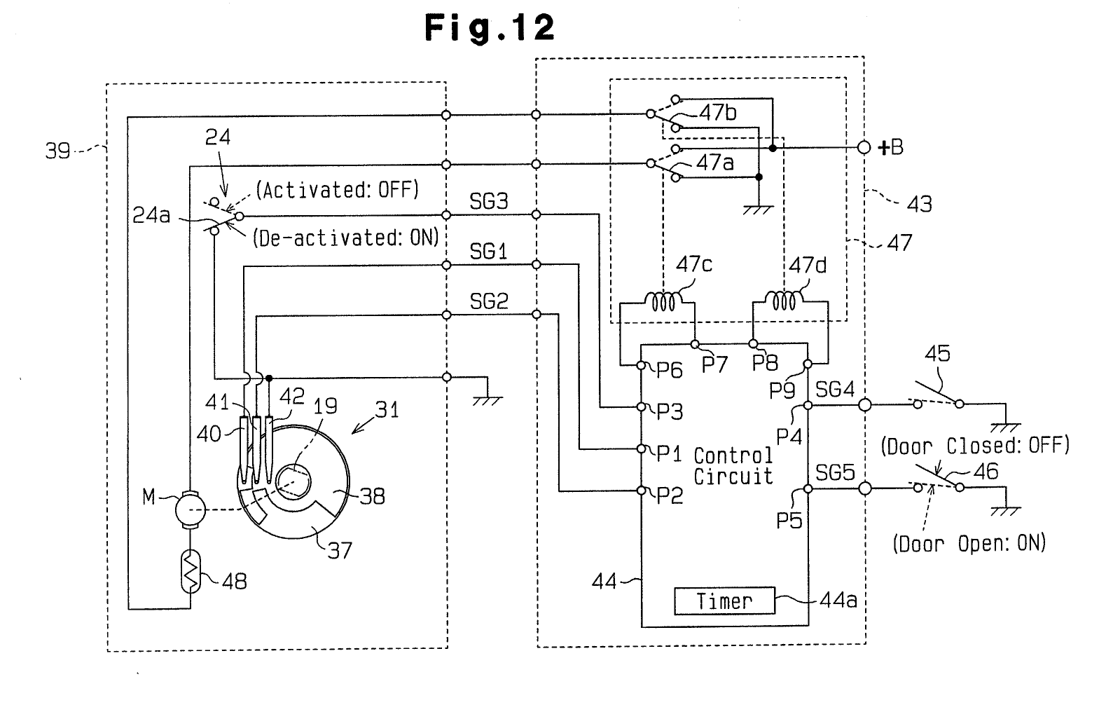

FIG. 12 shows the electric configuration of the door closer 3. A controller 43 is installed in the vehicle 1 for controlling the door closer 3. The controller 43 includes a control circuit 44 that includes a microcomputer.

The first contact element 40 is connected to an input port P1 of the control circuit 44, and the second contact element 41 is connected to an input port P2 of the control circuit 44. The third contact element 42 is grounded. If the first contact element 40 is electrically connected to the third contact element 42, the first contact element 40 is grounded through the third contact element 42. In this state, the rotational position sensor 31 sends a first detection signal SG1 at low level to the input port P1. Likewise, if the second contact element 41 is electrically connected to the third contact element 42, the second contact element 41 is grounded through the third contact element 42. In this state, the rotational position sensor 31 sends a second detection signal SG2 at low level to the input port P2.

If the first contact element 40 is electrically disconnected from the third contact element 42, the first contact element 40 becomes non-grounded. In this state, the rotational position sensor 31 sends the first detection signal SG1 at high level to the input port P1. Likewise, if the second contact element 41 is electrically disconnected from the third contact element 42, the second contact element 41 becomes non-grounded. In this state, the rotational position sensor 31 sends the second detection signal SG2 at high level to the input port P2.

As described, the rotational position sensor 31 generates the first detection signal SG1 and the second detection signal SG2. The first detection signal SG1 indicates the connection state between the first contact element 40 and the third contact element 42. The second detection signal SG2 indicates the connection state between the second contact element 41 and the third contact element 42. The control circuit 44 determines the rotational position of the connecting arm 17 in accordance with the levels of the first and second detection signals SG1, SG2.

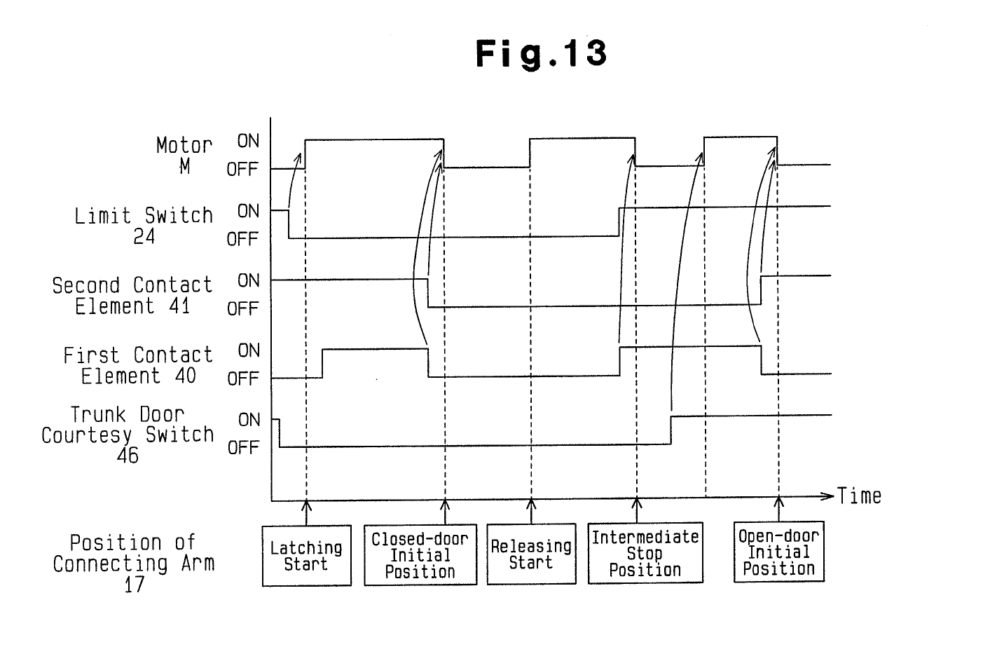

If the first contact element 40 is switched from ON state to OFF state and the second contact element 41 is switched from OFF state to ON state, as shown in FIG. 13, the first detection signal SG1 is switched from the low level to the high level and the second detection signal SG2 is switched from the high level to the low level. In this state, the control circuit 44 determines that the connecting arm 17 is located at the open-door initial position of FIGS. 2 and 6.

If the first and second contact elements 40, 41 are both switched from ON state to OFF state, the first and second detection signals SG1, SG2 are both switched from the low level to the high level. In this state, the control circuit 44 determines that the connecting arm 17 is located at the closed-door initial position of FIG. 8.

If the second contact element 41 is maintained in OFF state and the first contact element 40 is switched from OFF state to ON state, the second detection signal SG2 is maintained at high level and the first detection signal SG1 is switched from the high level to the low level. In this state, the control circuit 44 determines that the connecting arm 17 is located at the intermediate stop position of FIG. 10.

If the first and second contact elements 40, 41 are both maintained in ON state, or the first and second detection signals SG1, SG2 are both maintained at low level, the control circuit 44 determines that the connecting arm 17 is located between the open-door initial position and the closed-door initial position.

If the first and second contact elements 40, 41 are both maintained in OFF state, or the first and second detection signals SG1, SG2 are both maintained at high level, the control circuit 44 determines that the connecting arm 17 is located between the closed-door initial position and the open-door initial position. Further, if the first contact element 40 is maintained in ON state and the second contact element 41 is maintained in OFF state, or the first detection signal SG1 is maintained at low level and the second detection signal SG2 is maintained at high level, the control circuit 44 determines that the connecting arm 17 is located between the closed-door initial position and the open-door initial position.

The rotational position sensor 31 is a slidable contact type sensor. Thus, even if the power supply to the door closer 3 is suspended during the operation of the door closer 3 and is resumed later, the rotational position of the connecting arm 17 is precisely judged and the door closer 3 operates accurately.

An input port P3 of the control circuit 44 is grounded through the limit switch 24. When the movable piece 24a is operated, the limit switch 24 is turned off. When the movable piece 24a is not operated, the limit switch 24 is turned on. If the limit switch 24 is turned off, an operation signal OP3 at high level is supplied to the input port P3. If the limit switch 24 is turned on, the operation signal OP3 at low level is supplied to the input port P3.

An input port P4 of the control circuit 44 is grounded through an opener switch 45. The opener switch 45 is operated to open the trunk door 2 and is located in, for example, the passenger compartment of the vehicle 1. If the opener switch 45 is turned on to open the trunk door 2, an open-door signal SG4 at low level is supplied to the input port P4.

An input port P5 of the control circuit 44 is grounded through a trunk door courtesy switch 46. As shown in FIG. 1, the switch 46 is installed in the body frame of the vehicle 1 adjacent to the striker 4. If the trunk door 2 is open and thus does not contact the switch 46, the switch 46 is turned on. In contrast, if the trunk door 2 is closed and thus presses the switch 46, the switch 46 is turned off.

When the courtesy switch 46 is turned on, a courtesy signal SG5 at low level is supplied to the input port PS. If the courtesy switch 46 is turned off, the courtesy signal SG5 at high level is supplied to the input port P5.

The control circuit 44 controls the motor M in accordance with the signals from the rotational position sensor 31 and the switches 24, 45, 46.

A first coil 47c is located between a port P6 and a port P7 in the control circuit 44 for operating a first switch 47a in a relay 47. A second coil 47d is located between a port P8 and a port P9 in the control circuit 44 for operating a second switch 47b in the relay 47. The first switch 47a is connected to the positive pole of the motor M. The second switch 47b is connected to the negative pole of the motor M through a Positive Temperature Coefficient thermistor (hereinafter referred to as “PTC”) 48, which is a protective element. Each switch 47a, 47b grounds the associated pole of the motor M, when the associated coil 47c, 47d is not excited. To rotate the motor M in the positive direction, the control circuit 44 excites the first coil 47c to activate the first switch 47a. In this state, the positive pole of the motor M is connected to a battery B. To rotate the motor M in the negative direction, the control circuit 44 excites the second coil 47d to activate the second switch 47b. In this state, the negative pole of the motor M is connected to the battery B.

The control circuit 44 has a timer 44a. After the operational lever 22 turns off the limit switch 24, the timer 44a measures the time that elapses until the connecting arm 17, which has been located at the open-door initial position, reaches the closed-door initial position, or the time that the door closer 3 consumes for completing the latching operation of the trunk door 2.

If the measured time is not more than a predetermined reference value, the control circuit 44 determines that the latching operation of the trunk door 2 has been normally completed. However, if the measured time exceeds the reference value, the control circuit 44 determines that the latching operation of the trunk door 2 has been interfered. For example, if an object is clamped between the trunk door 2 and the body frame of the vehicle 1, the door closer 3 cannot complete the latching operation. In this case, the measured time exceeds the reference value.

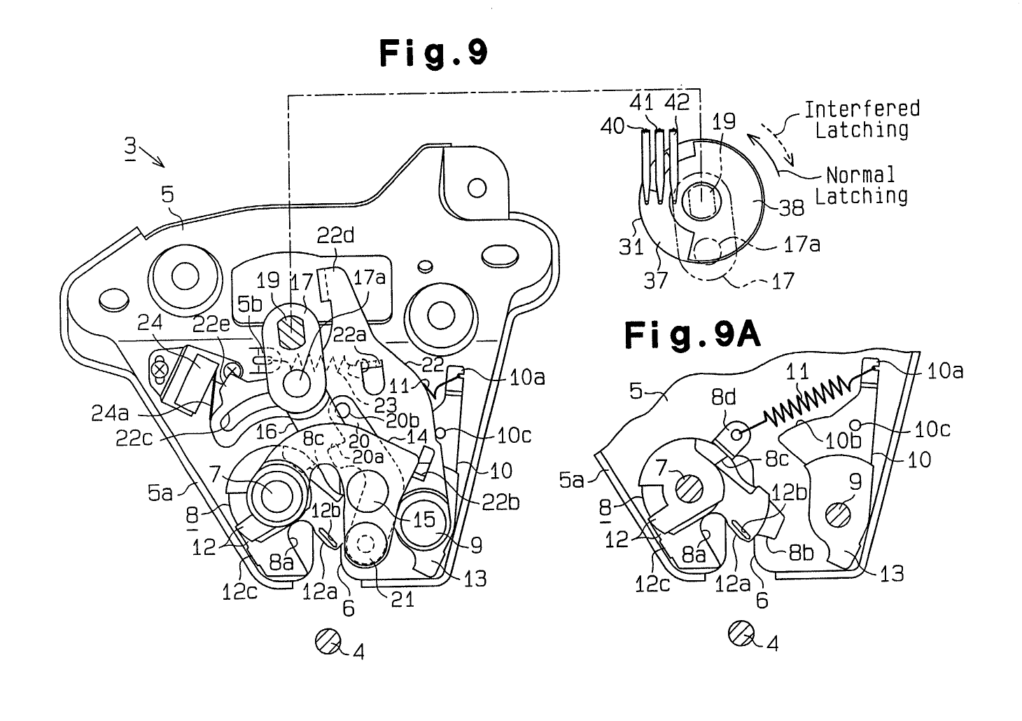

When determining that the latching operation of the trunk door 2 has been interfered, the control circuit 44 discontinues the latching operation of the door closer 3. The control circuit 44 then rotates the motor M in an inverse direction, or the negative direction. More specifically, by rotating the motor M in the negative direction, the control circuit 44 moves the connecting arm 17 to a limit position of FIG. 9 of the clockwise movement via the intermediate stop position of FIG. 10. The control circuit 44 then rotates the motor M in the positive direction to return the connecting arm 17 from the clockwise limit position to the open-door initial position of FIG. 2. The control circuit 44 determines that the connecting arm 17 is located at the clockwise limit position when the first contact element 40 is switched from ON state to OFF state while the second contact element 41 is maintained in OFF state, or when the first detection signal SG1 is switched from the low level to the high level while the second detection signal SG2 is maintained at high level.

Next, the operation of the door closer 3 will be described. The operation includes a door latching operation and a door releasing operation.

[Door Latching Operation]

The door latching operation is performed to fully close the trunk door 2. More specifically, when the latch 8 engages with the striker 4, the latch 8 is rotated to the fully latched position of FIGS. 8 and 8A, thus engaging the latch 8 with the first ratchet 10.

When the trunk door 2 is open, the latch 8 is located at the initial position and the connecting arm 17 is located at the open-door initial position, as shown in FIGS. 2 and 2A. In this state, the first contact element 40 is maintained in OFF state and the second contact element 41 is maintained in ON state (see FIG. 13). Thus, the first detection signal SG1 at high level is supplied to the input port P1 of the control circuit 44, while the second detection signal SG2 at low level is supplied to the input port P2 of the control circuit 44. The control circuit 44 determines that the connecting arm 17 is located at the open-door initial position in accordance with the first and second detection signals SG1, SG2.

Further, as shown in FIG. 2, the limit switch 24 is maintained in ON state such that the operation signal SG3 at low level is supplied to the input port P3 of the control circuit 44. In this state, the opener switch 45 of FIG. 12 is maintained in OFF state, and the open-door signal SG4 at high level is supplied to the input port P4 of the control circuit 44. Since the trunk door 2 is open, the courtesy switch 46 of FIG. 12 is maintained in ON state. Thus, the courtesy signal SG5 at low level is supplied to the input port P5 of the control circuit 44. In the state shown in FIGS. 2 and 2A, the control circuit 44 maintains the motor M in a de-activated state, in accordance with the signals SG1 to SG5.

If the trunk door 2 is manually moved in the direction to close the trunk door 2, the striker 4 enters the receiving groove 6 and strikes the damper 12a, as shown in FIG. 6A. The striker 4 thus rotates the latch 8 counterclockwise, as viewed in the drawing, against the force of the coil spring 11. The latch 8 is then located at the latching start position, as shown in FIGS. 6 and 6A. In this state, the force of the coil spring 23 acts to rotate the operational lever 22 and the second ratchet 20 counterclockwise, such that the engagement piece 20a of the second ratchet 20 engages with the engagement surface 8c. The engagement prevents the latch 8 from rotating further counterclockwise from the latching start position.

Further, as shown in FIG. 6, the projection 22e of the operational lever 22 moves the movable piece 24a of the limit switch 24, thus turning off the limit switch 24. In this state, the operation signal SG3 at high level is supplied to the input port P3 of the control circuit 44. The control circuit 44 then excites the first coil 47c of FIG. 12 to activate the first switch 47a, thus connecting the positive pole of the motor M to the battery B. Accordingly, the motor M rotates in the positive direction such that the door closer 3 starts the door latching operation (see FIG. 13). As the motor M rotates in the positive direction, the connecting arm 17 rotates counterclockwise from the open-door initial position of FIG. 6.

When the limit switch 24 is turned off with the operational lever 22, the control circuit 44 activates the timer 44a to measure the time consumed for the door latching operation. The control circuit 44 determines that the door latching operation has been normally completed if the connecting arm 17 reaches the closed-door initial position of FIG. 8 within the aforementioned reference time.

When the connecting arm 17 rotates counterclockwise, as viewed in FIG. 6, during the door latching operation, the drive cam 14, which is connected to the connecting arm 17 through the link 16, also rotates counterclockwise from the neutral position of FIG. 6. In this state, the second ratchet 20 connected to the drive cam 14 also rotates counterclockwise with respect to the support shaft 7. The engagement piece 20a of the second ratchet 20 engages with the engagement surface 8a of the latch 8. Thus, the second ratchet 20 forcibly rotates the latch 8 counterclockwise. When the second ratchet 20 moves, the follower pin 20b is guided by the guide groove 22c of the operational lever 22.

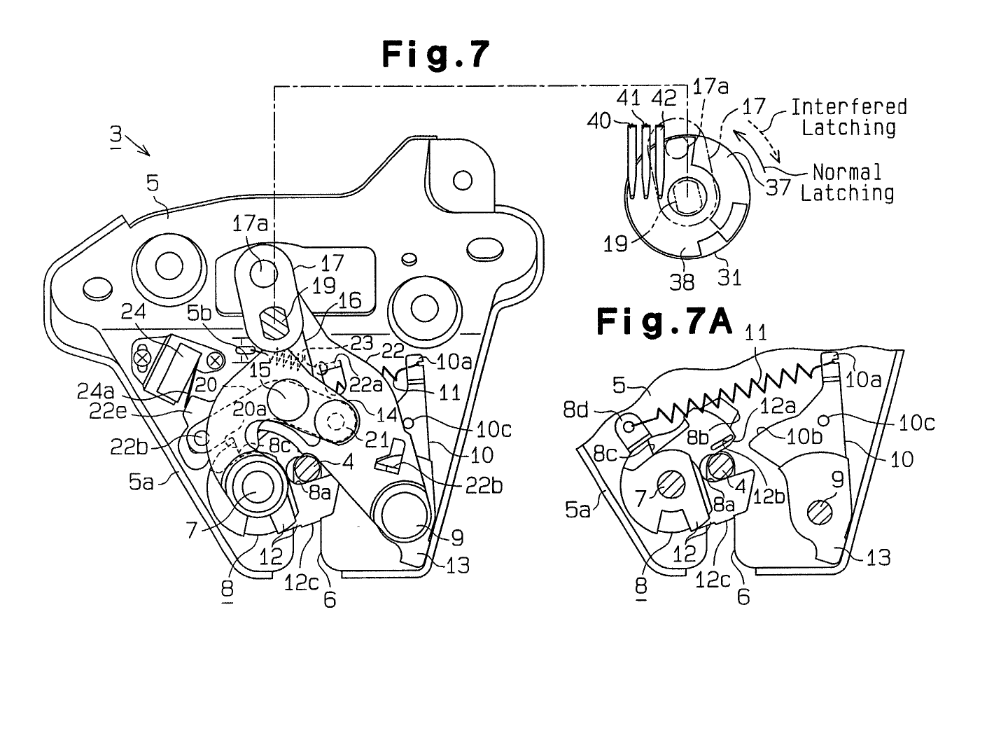

When the connecting arm 17 reaches its top dead center as viewed in FIG. 7, the drive cam 14, the second ratchet 20, and the latch 8 are located at their limit positions in the counterclockwise movement. More specifically, the latch 8 moves from the position of FIG. 6A to the position of FIG. 7A via the fully latched position. In this period, the engagement piece 10b of the first ratchet 10 abuts against the portion of the latch 8 that has the engagement surface 8b. However, the first ratchet 10 does not engage with the latch 8 and rotates further clockwise with respect to the support shaft 9, regardless of the latch 8. In the state shown in FIG. 7A, the engagement surface 8b is spaced from the engagement piece 10b.

When the connecting arm 17 further rotates counterclockwise from the position of FIG. 7, the drive cam 14 and the second ratchet 20 rotate clockwise, as viewed in the drawing. In this state, the force of the coil spring 11 acts to rotate the latch 8 clockwise such that the engagement piece 10b of the first ratchet 10 engages with the engagement surface 8b of the latch 8, as shown in FIG. 8A. Accordingly, the latch 8 is located at the fully latched position and does not rotate further clockwise. In this manner, the trunk door 2 is fully closed, or is located at the fully closed position.

Even after the latch 8 is located at the fully latched position, the control circuit 44 continuously actuates the motor M, thus rotating the connecting arm 17 further counterclockwise to the closed-door initial position of FIG. 8. When the connecting arm 17 reaches the closed-door initial position, the drive cam 14 restores its neutral position. In this state, the first and second contact elements 40, 41 are both switched from ON state to OFF state. The detection signals SG1, SG2 that are supplied to the associated input ports P1, P2 of the control circuit 44 are thus switched from the low level to the high level. The control circuit 44 then determines that the connecting arm 17 is located at the closed-door initial position and de-excites the first coil 47c. This de-activates the first switch 47c, thus blocking the power supply to the motor M. Accordingly, the door latching operation is completed.

As described, the control circuit 44 determines that the door latching operation has been normally completed if the connecting arm 17 reaches the closed-door initial position within the reference time after the limit switch 24 has been turned off. However, if the connecting arm 17 does not reach the closed-door initial position within the reference time, the control circuit 44 determines that the door latching operation has been interfered by, for example, an object caught between the trunk door 2 and the body frame of the vehicle 1. If this is the case, the control circuit 44 de-excites the first coil 47c immediately, and excites the second coil 47d. The motor M thus starts to rotate in an inverse direction, or the negative direction. In this state, the connecting arm 17 rotates clockwise and reaches the clockwise limit position of FIG. 9 via the open-door initial position of FIG. 6 and the intermediate stop position of FIG. 10. Subsequently, the control circuit 44 rotates the motor M in the positive direction, thus rotating the connecting arm 17 counterclockwise to move the connecting arm 17 from the clockwise limit position of FIG. 9 to the open-door initial position of FIG. 2.

When the connecting arm 17 restores the open-door initial position, the drive cam 14 is located at the neutral position. In this state, if the connecting arm 17 rotates clockwise, as viewed in the drawing, the outer periphery of the drive cam 14 abuts against the projection 22b of the operational lever 22. Thus, if the connecting arm 17 rotates further clockwise to the intermediate stop position of FIG. 10, the drive cam 14 rotates the operational lever 22 clockwise with respect to the support shaft 9. Further, since the engagement pin 10c of the first ratchet 10 abuts against the outer periphery of the operational lever 22, the first ratchet 10 rotates clockwise with respect to the support shaft 9, together with the operational lever 22.

Accordingly, the engagement piece 10b of the first ratchet 10 disengages from the engagement surface 8b of the latch 8, as shown in FIGS. 10 and 10A. Further, the second ratchet 20, which is connected to the operational lever 22 through the follower pin 20b, separates from the latch 8, together with the operational lever 22. Thus, the engagement piece 20a of the second ratchet 20 disengages from the engagement surface 8c of the latch 8. In this state, the force of the coil spring 11 acts to rotate the latch 8 clockwise with respect to the support shaft 7. The latch 8 thus returns to the initial position, or the position at which the latch 8 abuts against the side wall 5a of the base plate 5, as shown in FIG. 10A, thus releasing the striker 4 from the latch 8. As a result, the trunk door 2 may be manually opened to remove the object caught between the trunk door 2 and the body frame.

In this state, the connecting arm 17 rotates further clockwise from the intermediate stop position of FIG. 10 to the clockwise limit position of FIG. 9. When the first and second contact elements 40, 41 are both held in OFF state, the control circuit 44 determines that the connecting arm 17 has reached the clockwise limit position of FIG. 9. In this state, the control circuit 44 excites the first coil 47c and de-excites the second coil 47d, thus operating the first and second switches 47a, 47b to rotate the motor M in the inverse direction, or the positive direction. Accordingly, the connecting arm 17 rotates counterclockwise to move from the clockwise limit position of FIG. 9 to the open-door initial position of FIG. 2. If the first contact element 40 is switched to OFF state and the second contact element 41 is switched to ON state, the control circuit 44 determines that the connecting arm 17 has reached the open-door initial position. The control circuit 44 thus stops the motor M. That is, the door closer 3 restores the state before starting the door latching operation, or the state shown in FIGS. 2 and 2A.

[Door Releasing Operation]

The door releasing operation is performed to open the trunk door 2 when the trunk door 2 is fully closed. More specifically, the latch 8 is disengaged from the first ratchet 10 and is rotated to the initial position of FIGS. 2 and 2A, thus releasing the striker 4 from the latch 8.

When the trunk door 2 is fully closed, the latch 8 is located at the fully latched position and the connecting arm 17 is located at the closed-door initial position, as shown in FIGS. 8 and 8A. In this state, the first and second contact elements 40, 41 are both maintained in OFF state (see FIG. 13). Thus, the first and second detection signals SG1, SG2 that are supplied to the associated input ports P1, P2 of the control circuit 44 are maintained at high level. The control circuit 44 determines that the connecting arm 17 is located at the closed-door initial position, in accordance with the detection signals SG1, SG2.

When the opener switch 45 of FIG. 12 is turned on, the open-door signal SG4 supplied to the input port P4 of the control circuit 44 is switched from the high level to the low level. The control circuit 44 then excites the first coil 47c to activate the first switch 47a, thus rotating the motor M in the positive direction. Accordingly, the door closer 3 starts the door releasing operation (see FIG. 13). As the motor M rotates in the positive direction, the connecting arm 17 rotates counterclockwise from the closed-door initial position, as viewed in FIG. 8.

When the connecting arm 17 rotates counterclockwise, the drive cam 14, which is connected to the connecting arm 17 through the link 16, rotates clockwise with respect to the support shaft 7 from the neutral position of FIG. 8. The drive cam 14 then abuts against the projection 22b of the operational lever 22, thus rotating the operational lever 22 clockwise with respect to the support shaft 9. In this state, since the engagement pin 10c abuts against the outer periphery of the operational lever 22, the first ratchet 10 rotates clockwise with respect to the support shaft 9, together with the operational lever 22.

Accordingly, the engagement piece 10b of the first ratchet 10 disengages from the engagement surface 8b of the latch 8, as shown in FIGS. 9 and 9A. Further, the second ratchet 20, which is connected to the operational lever 22 through the follower pin 20b, separates from the latch 8, together with the operational lever 22. The engagement piece 20a of the second ratchet 20 thus disengages from the engagement surface 8c of the latch 8. In this state, the force of the coil spring 11 acts to rotate the latch 8 clockwise with respect to the support shaft 7. The latch 8 thus returns to the initial position of FIG. 9A, or the position at which the latch 8 abuts against the side wall 5a of the base plate 5. The latch 8 then releases the striker 4. As a result, the trunk door 2 is released from the fully closed position.

Even after the latch 8 restores the initial position, the control circuit 44 continuously rotates the motor M in the positive direction, thus rotating the connecting arm 17 further counterclockwise to the intermediate stop position, as viewed in FIG. 10. If the first contact element 40 is switched from OFF state to ON state while the second contact element 41 is maintained in OFF state, the control circuit 44 determines that the connecting arm 17 has reached the intermediate stop position. The control circuit 44 thus de-excites the first and second coils 47c, 47d to stop the motor M.

The hinge mechanism 2a, which is shown in FIG. 2, includes a popup spring (not shown). When the latch 8 releases the striker 4, the popup spring moves the trunk door 2 slightly away from the fully closed position in a direction to open the trunk door 2. The trunk door 2 is thus located at its released position. In this state, the door closer 3 is slightly spaced from the striker 4, as shown in FIGS. 9 and 10.

The courtesy switch 46, which is shown in FIGS. 1 and 12, is maintained in OFF state until the trunk door 2 is moved to a predetermined position that is slightly farther from the released position in the door opening direction. In other words, the courtesy switch 46 is maintained in OFF state as long as the trunk door 2 is located closer to the released position than the predetermined position. The courtesy switch 46 is only turned on when the trunk door 2 is moved to the predetermined position or farther in the door opening direction. That is, if the striker 4 is only released from the latch 8, the control circuit 44 determines that the trunk door 2 is still closed and maintains the courtesy switch 46 in OFF state.

If the trunk door 2 is located at the released position and a certain force acts to urge the trunk door 2 in the door closing direction, the trunk door 2 moves from the released position in that direction. The striker 4 then presses the damper 12a of the latch 8. However, as long as the connecting arm 17 is located at the intermediate stop position of FIG. 10, the drive cam 14 operates to hold the first and second ratchets 10, 20 at positions at which the ratchets 10, 20 cannot engage with the latch 8. Thus, even if the striker 4 presses the latch 8 to rotate counterclockwise from the initial position of FIG. 10, the remaining components of the door closer 3 are held at the positions of FIG. 10 and do not move. Accordingly, the limit switch 24 is maintained in ON state, and the door closer 3 does not start the door latching operation.

If the trunk door 2 is manually moved from the state of FIG. 10 in the door opening direction and the courtesy switch 46 is turned on, the courtesy signal SG5 that is supplied to the input port P5 of the control circuit 44 is switched from the high level to the low level. The control circuit 44 then determines that the trunk door 2 has been intentionally opened and rotates the motor M in the positive direction. This rotates the connecting arm 17 counterclockwise to the open-door initial position of FIG. 2. When the first contact element 40 is switched from ON state to OFF state and the second contact element 41 is switched from OFF state to ON state, the control circuit 44 determines that the connecting arm 17 has reached the open-door initial position. The control circuit 44 thus stops the motor M. Accordingly, the door closer 3 is held in the state shown in FIG. 2 and is ready for starting a subsequent door latching operation.

The illustrated embodiment has the following advantages.

After the door closer 3 completes the door releasing operation, the courtesy switch 46 is maintained in OFF state until the trunk door 2 is moved to the aforementioned position farther than the released position in the door opening direction. As long as the courtesy switch 46 is turned off, the control circuit 44 maintains the motor M in the de-activated state to hold the connecting arm 17 at the intermediate stop position of FIG. 10. Accordingly, the first and second ratchets 10, 20 are held at the positions at which the ratchets 10, 20 cannot engage with the latch 8. As a result, even if a certain force acts to urge the trunk door 2 in the door closing direction after the door releasing operation has been completed, the door closer 3 does not start the door latching operation.

That is, in the illustrated embodiment, the first and second ratchets 10, 20 are held at the positions at which the ratchets 10, 20 cannot engage with the latch 8 after the door releasing operation is completed, unless the trunk door 2 is intentionally opened. This structure prevents the door closer 3 from performing the door latching operation at an undesired timing after completing the door releasing operation.

The rotational position sensor 31 is a slidable contact type. Thus, even if the power supply to the door closer 3 is suspended during the operation of the door closer 3 and is resumed afterward, the position of the connecting arm 17 is precisely judged. Accordingly, the door closer 3 is operated accurately.

When the trunk door 2 is fully closed, the switches 24, 46 and the contact elements 40, 41 are all turned off. That is, the ports P1 to P3 and P5 of the control circuit 44 are non-grounded. Further, if the opener switch 45 is turned off, the port P4 of the control circuit 44 is non-grounded. Generally, the time during which the trunk door 2 is fully closed is longer than the time during which the trunk door 2 is open. Also, the time during which the opener switch 45 is maintained as turned off is longer than the time during which the opener switch 45 is maintained as turned on. Accordingly, the time during which the ports P1 to P5 are grounded is minimized, and the current that flows from the input ports P1 to P5 to the ground is also minimized. This reduces the power consumption of the door closer 3.

It should be apparent to those skilled in the art that the present invention may be embodied in many other specific forms without departing from the spirit or scope of the invention. Particularly, it should be understood that the invention may be embodied in the following forms.

In the illustrated embodiment, the drive cam 14 operates to separate the operational lever 22 from the latch 8 such that the first and second ratchets 10, 20 are maintained at the positions at which the ratchets 10, 20 cannot engage with the latch 8. However, other components than the drive cam 14 may be used for maintaining the first and second ratchets 10, 20 at those positions. For example, an actuator such as an electromagnetic solenoid may be used for separating the operational lever 22 from the latch 8.

In the illustrated embodiment, the door closer 3 performs both the door latching operation and the door releasing operation by means of the motor M. However, the present invention may be applied to a door closer that uses the motor M only for the door releasing operation. Alternatively, the present invention may be applied to a door closer that does not use the motor M either for the door latching operation or the door releasing operation.

The courtesy switch 46 may be located in the trunk door 2, instead of the body frame of the vehicle 1. Further, the door closer 3 may have an additional switch for detecting whether or not the trunk door 2 is closed, apart from the courtesy switch 46.

The rotational position sensor 31 may be other types than the slidable contact type. The rotational position sensor 31 may be, for example, a non-contact type.

The present invention is not restricted to the door closer 3 for the trunk door 2. That is, the present invention may be applied to a door closer that closes other types of doors including those of objects other than vehicles.

Therefore, the present examples and embodiments are to be considered as illustrative and not restrictive and the invention is not to be limited to the details given herein, but may be modified within the scope and equivalence of the appended claims.

1. A door closer that holds a door at a fully closed position by engaging with a prescribed engagement member, wherein, when the engagement member is disengaged from the door closer, the door moves to a released position that is located slightly separate from the fully closed position in a door opening direction, the door closer comprising:
a latch, which engages with the engagement member, wherein the latch rotates between an initial position at which the latch receives the engagement member and a fully latched position, and wherein, when the latch rotates from the initial position to the fully latched position after receiving the engagement member, the door is moved to the fully closed position;
an urging member, which urges the latch toward the initial position;
a ratchet, which is urged toward the latch, wherein, when the latch reaches the fully latched position, the ratchet engages with the latch to hold the latch at the fully latched position;
an actuation mechanism, which separates the ratchet from the latch to disengage the ratchet from the latch, wherein, when the ratchet disengages from the latch, the urging member returns the latch from the fully latched position to the initial position such that the engagement member disengages from the latch and the door moves from the fully closed position to the released position; and
a detection device, which detects that the door is located at a predetermined position separate from the released position in the door opening direction, wherein the actuation mechanism holds the ratchet at a position at which the ratchet cannot engage with the latch after the ratchet disengages from the latch, unless the detection device detects that the door is located at the predetermined position.

2. The door closer as set forth in claim 1, further comprising:
a motor, which drives the actuation mechanism; and
a controller, which controls the motor.

3. The door closer as set forth in claim 2, wherein the controller maintains the motor in a stopped state after the ratchet disengages from the latch, unless the detection device detects that the door is located at the predetermined position.

4. The door closer as set forth in claim 2, wherein the controller controls the motor such that the actuation mechanism disengages the ratchet from the latch in accordance with an external instruction.

5. The door closer as set forth in claim 1, wherein:
the latch rotates from the initial position to the fully latched position via a latching start position;
the ratchet is a first ratchet;
the door closer further includes a second ratchet, which is urged toward the latch, wherein the second ratchet engages with the latch when the latch reaches the latching start position from the initial position; and
the actuation mechanism moves the second ratchet such that the second ratchet rotates the latch to the fully latched position when the second ratchet engages with the latch.

6. The door closer as set forth in claim 2, wherein:
the latch rotates from the initial position to the fully latched position via a latching start position;
the ratchet is a first ratchet;
the door closer further includes a second ratchet, which is urged toward the latch, wherein the second ratchet engages with the latch when the latch reaches the latching start position from the initial position; and
the controller instructs the actuation mechanism to move the second ratchet such that the second ratchet rotates the latch to the fully latched position when the second ratchet engages with the latch.

7. The door closer as set forth in claim 6, wherein the controller controls the motor such that the actuation mechanism disengages the second ratchet from the latch in accordance with an external instruction.

8. The door closer as set forth in claim 2, wherein the actuation mechanism includes a rotary body driven by the motor and a rotational position sensor that detects a rotational position of the rotary body, and the controller controls the motor in accordance with the rotational position of the rotary body detected by the rotational position sensor.

9. The door closer as set forth in claim 8, wherein the rotational position sensor includes a conductor that is located on the rotary body to form a predetermined conductive pattern on the rotary body and a plurality of contact elements that contact the conductive pattern, and the controller determines the rotational position of the rotary body in accordance with signals from the contact elements.

10. The door closer as set forth in claim 1, wherein the detection device is a contact type switch.

11. A door closer that holds a door at a fully closed position by engaging with a prescribed engagement member, wherein, when the engagement member is disengaged from the door closer, the door moves to a released position that is located slightly separate from the fully closed position in a door opening direction, the door closer comprising:
a latch, which engages with the engagement member, wherein the latch rotates between an initial position at which the latch receives the engagement member and a fully latched position, and wherein, when the latch rotates from the initial position to the fully latched position after receiving the engagement member, the door is moved to the fully closed position;
an urging member, which urges the latch toward the initial position;
a ratchet, which is urged toward the latch, wherein, when the latch reaches the fully latched position, the ratchet engages with the latch to hold the latch at the fully latched position;
an actuation mechanism, which separates the ratchet from the latch to disengage the ratchet from the latch, wherein, when the ratchet disengages from the latch, the urging member returns the latch from the fully latched position to the initial position such that the engagement member disengages from the latch and the door moves from the fully closed position to the released position;
a motor, which drives the actuation mechanism;
a controller, which controls the motor; and
a detection device, which detects that the door is located at a predetermined position separate from the released position in the door opening direction, wherein the controller maintains the motor in a stopped state such that the actuation mechanism holds the ratchet at a position at which the ratchet cannot engage with the latch after the ratchet disengages from the latch, unless the detection device detects that the door is located at the predetermined position.

12. The door closer as set forth in claim 11, wherein the controller controls the motor such that the actuation mechanism disengages the ratchet from the latch in accordance with an external instruction.

13. The door closer as set forth in claim 11, wherein the actuation mechanism includes a rotary body driven by the motor and a rotational position sensor that detects a rotational position of the rotary body, and the controller controls the motor in accordance with the rotational position of the rotary body detected by the rotational position sensor.

14. The door closer as set forth in claim 13, wherein the rotational position sensor includes a conductor that is located on the rotary body to form a predetermined conductive pattern on the rotary body and a plurality of contact elements that contact the conductive pattern, and the controller determines the rotational position of the rotary body in accordance with signals from the contact elements.

15. The door closer as set forth in claim 11, wherein the detection device is a contact type switch.

16. A door closer that holds a door at a fully closed position by engaging with a prescribed engagement member, wherein, when the engagement member is disengaged from the door closer, the door moves to a released position that is located slightly separate from the fully closed position in a door opening direction, the door closer comprising:
a latch, which engages with the engagement member, wherein the latch rotates between an initial position at which the latch receives the engagement member and a fully latched position, and wherein, when the latch rotates from the initial position to the fully latched position via a latching start position between the initial position and the fully latched position after receiving the engagement member, the door moves to the fully closed position;
an urging member, which urges the latch toward the initial position;
a latching ratchet, which is urged toward the latch, wherein, when the latch reaches the latching start position from the initial position, the latching ratchet engages with the latch to rotate the latch to the fully latched position;
a holding ratchet, which is urged toward the latch, wherein, when the latch reaches the fully latched position, the holding ratchet engages with the latch to hold the latch at the fully latched position;
an actuation mechanism, which separates the latching ratchet and the holding ratchet from the latch to disengage the ratchets from the latch, wherein, when the ratchets disengage from the latch, the urging member returns the latch from the fully latched position to the initial position such that the engagement member disengages from the latch and the door moves from the fully closed position to the released position;
a motor, which drives the actuation mechanism;
a controller, which controls the motor; and
a detection device, which detects that the door is located at a predetermined position separate from the released position in the door opening direction, wherein the controller maintains the motor in a stopped state such that the actuation mechanism holds each ratchet at a position at which the ratchet cannot engage with the latch after the ratchets disengage from the latch, unless the detection device detects that the door is located at the predetermined position.
